(19) United States
(12) Patent Application Publication
(10) Pub. No.: US 2020/0209427 A1
(43) Pub. Date: Jul. 2, 2020

(54) SYSTEM AND METHOD FOR ACQUIRING AND INVERTING SPARSE-FREQUENCY DATA

(71) Applicant: King Abdullah University of Science and Technology, Thuwal (SA)

(72) Inventor: Tariq Ali M. ALKHALIFAH, Thuwal (SA)

(21) Appl. No.: 16/303,848

(22) PCT Filed: May 26, 2017
(86) PCT No.: PCT/IB2017/053120

§ 371 Date: Nov. 21, 2018

Related U.S. Application Data
(60) Provisional application No. 62/341,909, filed on May 26, 2016.

(51) Int. Cl. G01V 99/00; G01V 1/30

(52) U.S. Cl. CPC G01V 99/005; G01V 2210/66; G01V 2210/622; G01V 1/303

(57) ABSTRACT

A method of imaging an object includes generating a plurality of mono-frequency waveforms and applying the plurality of mono-frequency waveforms to the object to be modeled. In addition, sparse mono-frequency data is recorded in response to the plurality of mono-frequency waveforms applied to the object to be modeled. The sparse mono-frequency data is cross-correlated with one or more source functions each having a frequency approximately equal to each of the plurality of mono-frequency waveforms to obtain monochromatic frequency data. The monochromatic frequency data is utilized in an inversion to converge a model to a minimum value.

### CROSS-REFERENCES TO RELATED APPLICATIONS

The present application claims the benefit under 35 USC 119(e) of U.S. Provisional Application No. 62/341,909, filed May 26, 2016; the full disclosure of which is incorporated herein by reference in its entirety.

### TECHNICAL FIELD

This invention relates generally to the detection and mapping of underground structures.

### BACKGROUND

The mapping of underground or subsurface structures generally relies on acoustic, elastic or electromagnetic waves propagated along the subsurface structures. As the propagated wave encounters the subsurface structures, the propagated wave is reflected, scattered and/or refracted. Receiver stations (such as geophones) are utilized to monitor the reflected, scattered and/or refracted signal, wherein analysis of the monitored signals allows information about the subsurface structures to be determined.

However, the effects of reflection, scattering and refraction are not always clean, linear or susceptible to simplistic analysis. Models utilized to analyze the reflected signal typically require some form of correction, iterative analysis, filtering or adjustment of parameters, which results in inaccuracies.

For example, wavefield inversion and tomography require a process of fitting modeled data generated using a computing device and corresponding to some model (possibly initially to a guess) to the observed measurements from an actual experiment. If the modeled data does not fit (i.e., match) the measured or observed data using some fitting criteria, the difference is used to update the model used for modeling. The update process, however, suffers usually from the sinusoidal nature of wavefields, and the complexity of the inverted model yielding a highly non-linear relation. Thus, any update in the model based on the iterative nature of the inversion or tomographic process could lead us to a local minima (or local maxima) model that is not accurate. In particular, local minima (or maxima) may lead the model to an incorrect result for the global minima (or maxima), when in fact the minima (or maxima) found is merely a local minima (or local maxima). Thus, the cost of data acquisition and inversion can be large and the applications inefficient in accurately modeling the sub-surface structures.

### BRIEF DESCRIPTION OF THE DRAWINGS

FIG. 1 is a flowchart that illustrates steps utilized to collect sparse waveform data for utilization in a waveform inversion or tomography process according to an embodiment of the present invention.

FIG. 2 is a schematic of a single-source system according to an embodiment of the present invention.

FIG. 3 is a schematic of a multi-source acquisition system according to an embodiment of the present invention.

FIG. 4a is a time-series seismic trace and FIG. 4b illustrates the frequency range of the seismic trace.

FIGS. 5a and 5b illustrate cross-correlation of the data shown in FIG. 4a with first and second mono-frequency time series, respectively, having a length approximately equal as the length of the data according to an embodiment of the present invention.

FIGS. 6a and 6b illustrate cross-correlation of the data shown in FIG. 4a with first and second mono-frequency time series, respectively, having a length less than the length of the data according to an embodiment of the present invention.

FIG. 7 is a cross-sectional view of a subsurface structure model, with both the lateral distance and depth expressed in kilometers.

FIGS. 8a and 8b illustrate the gradients generated as a result of a mono-frequency wavefield generated at approximately 5 Hz and 7 Hz, respectively, according to an embodiment of the present invention.

FIGS. 9a-9f illustrate the result of applying various low-cut scattering angle filters to the gradient shown in FIG. 8a (based on a 5 Hz source), according to an embodiment of the present invention.

FIGS. 10a-10f illustrate the result of applying various low-cut scattering angle filters to the gradient shown in FIG. 8b (based on a 7 Hz source), according to an embodiment of the present invention.

### DETAILED DESCRIPTION

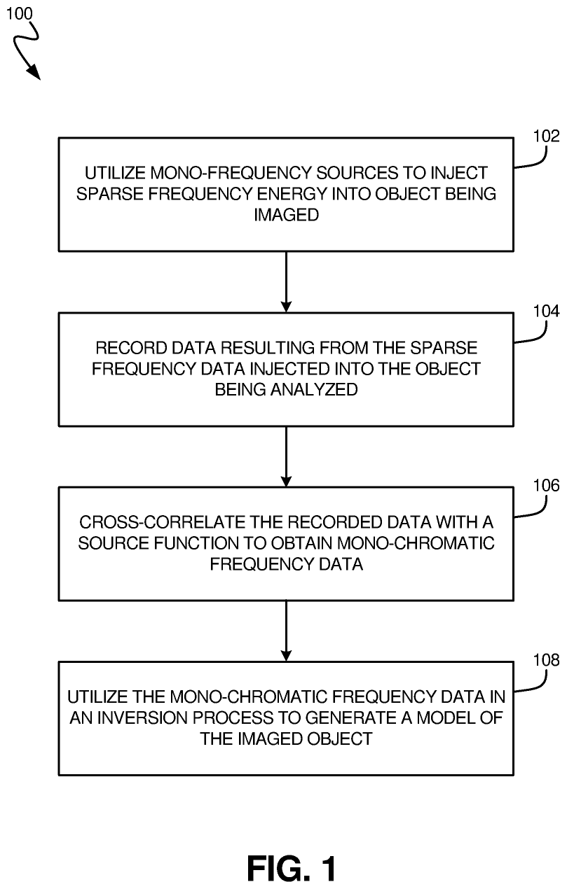

The present invention provides a system and method of utilizing a sparse frequency acquisition source (or sources) to acquire data for waveform inversion or tomography. The concept is based on the fact that our typical model of the Earth consists of long wavelength changes and very short wavelength interfaces. A frequency that produces wavelengths (inversely proportional to the wave velocity) that are in between these two extremes (the background and the interface) can be used to resolve both the long wavelength information (from the ray embedded features of wavefields) and the short wavelength information from the reflections in the data. This frequency, and as we need a collection of frequencies as velocity varies, are referred to as sparse frequency data. A scattering angle filter can be used to guide us to the proper updates from the sparse frequency data. Utilization of a plurality of mono-frequency signals allows for the accommodation of large variations in seismic wave speeds inside the Earth acquisition of high resolution images from higher frequency source signals. Details regarding the system and method of utilizing sparse frequency sources to acquire data for waveform inversion are described with respect to FIGS. 1-3, below.

FIG. 1 is a flowchart that illustrates a method 100 of utilizing a sparse range of frequencies to acquire imaging data according to an embodiment of the present invention. At step 102, one or more mono-frequency or narrow band sources are utilized to inject a plurality of sparse frequency waveforms (i.e., energy) into the area to be imaged (e.g., the Earth). Sparse frequency waveforms may be acoustic, elastic, electromagnetic, or some other well type of wave capable of being delivered to the medium to be imaged and sensed. The waveform of each mono-frequency source may be expressed as:

fⱼ(ωᵢ, t)=A(t)sin ωᵢt Equation 1

wherein ωᵢ represents the angular frequency of the source function, and A(t) is the amplitude of the frequency, which in some embodiments varies with time t to provide a taper to the mono-frequency waveform. The wavelength selected depends on the application and the required resolution. A typical model utilized in Full Wave Inversion (FWI) applications consists of long wavelength changes and very short wavelength interfaces. Selection of sparse frequencies between these two extremes can be utilized to resolve both the long wavelength information and the short wavelength information. In one embodiment, a single source is utilized to generate the sparse frequency waveforms at the same time or at different times (i.e., plurality of mono-frequency waveforms created simultaneously or sequentially). In other embodiments, a plurality of sources are utilized, wherein each source generates a mono-frequency signal at different frequencies. In one embodiment, mapping of subsurface features utilizes frequencies acquired within a range between 7 and 40 Hertz (Hz).

At step 104, data is recorded by one or more receivers in response to the plurality of mono-frequency waveforms. The received data may be represented by a vector dⱼ(t), where j corresponds to the source index, and the elements of the vector dⱼ correspond to each receiver. In this way, the plurality of mono-frequency sources are utilized to acquire sparse mono-frequency data.

At step 106, the recorded data dⱼ(t) is cross-correlated in time with a source function (i.e., a vibrator pilot signal or other mono-frequency time series signal) to obtain monochromatic frequency data. The source function may be expressed as:

g(ω₀, t)=B(t)sin ω₀t Equation 2

where ω₀ tends to be close or equal to one of the ωᵢ, and B is an amplitude as a function of time and could be close to or equal to A. The length of this function or time series determines the resolution (i.e., frequency) of the sparse mono-frequency nature of the resulting data and allows for the separation or de-blending of the recorded data dⱼ(t). The length of the time series is selected to ensure the orthogonality of the multi-frequency series, which is achieved by using sampling theory. In particular, sampling theory dictates that full separation is achieved when the time length of the source function is the inverse of the minimum frequency sampling desired for the sparse-frequency representation (i.e., the difference between two consecutive frequencies ωₖ. In one embodiment, recorded data dⱼ(t) is cross-correlated with a plurality of source functions, each source function having a frequency approximately equal to one of the mono-frequency sources injected into the earth. The source function(s) may be derived directly from the mono-frequency sources injected into the earth, or may be generated separately based on information provided regarding the mono-frequency sources utilized.

In one embodiment, the cross-correlation process to obtain monochromatic frequency data can be expressed as:

dᵢ(ω₀, t)=∫dᵢ(t+τ)g(ω₀, τ)dτ τ Equation 3

The cross-correlation process allows for the separation or de-blending of the simultaneous recordings monitored by each receiver. In particular, this process allows recorded data existing at a particular frequency (i.e., that shared by the vibrator pilot signal or source function expressed as ω₀ in Equation 3) to be extracted from the received data dⱼ(t), referred to herein as the sparse-frequency dataset. In one embodiment, the extraction is based on a frequency domain representation of the recorded data. In other embodiments, the extraction is based on a single frequency Fourier transform. In the embodiment utilizing a single frequency Fourier transform, the length of g(ω₀, t) in the time domain can be obtained by sampling the mono-frequency source function ωᵢ, Δω, where t could extend to at least 2π/Δω. The single frequency Fourier transform will still contain energy corresponding to other frequency signals as the time series is finite. In another embodiment, a deconvolution can be utilized to obtain the monochromatic data, and that can be extracted using a Fourier transform expressed as:

Dᵢ(ωₛ)=∫dᵢ(ω₀, t)e^{-iωst}dt Equation 4

where Dᵢ is the complex number data vector in the frequency domain. For simultaneous sources the function g(ωₖ, t) corresponds to various frequencies, all of which may correspond to those defined by the source functions associated with each source. Equation 4 may be utilized to separate the recorded data as each cross-correlation provides data for the frequency (or near to the frequency) utilized in the cross-correlation, wherein the resolution depends on the length of the cross-correlation function. As discussed above, full separation of the received data is achieved when the length of time of the source function is the inverse of the minimum frequency sampling desired for the mono-frequency representation (i.e., the difference between two consecutive frequencies ωₖ). That is, using a longer source function in the correlation results in higher resolution (in frequency) of the output. In addition, the length of the time series is also chosen to insure the orthogonally of the multi-frequency series. For example, if the acquired frequencies range from 7 to 40 Hz with a sampling of 2 Hz, then the length of the source function should be not less than 1 second in order to allow for full de-blending of the data to single source data.

As discussed above, providing a monochromatic time series to cross correlate with the recorded data in the time or frequency domain provides wavelengths in the wavefield in between those needed to resolve the long wavelength components of the smooth part of the velocity model and short wavelength components necessary to resolve the interfaces in the velocity model.

At step 108, the frequency domain data (i.e., sparse-frequency dataset) is utilized in an inversion process in which the frequency domain data is compared to modeled data, wherein differences between the modeled data and observed data (i.e., the sparse-frequency dataset) is utilized to correct the model used to generate the modeled data. In one embodiment the inversion process is a standard full waveform inversion process. In other embodiments, the inversion process may make use of other methods, such as waveform tomography, reflection full wave inversion (RWI), migration velocity analysis (MVA), or a combination of one or more of these methods. In one embodiment, scattering angle based filtering is utilized in making the sparse frequency dataset to ensure convergence to a credible model (i.e., prevent convergence to a local minimum). Energy in the waveform or tomography inversion gradient function, Δ(ωₛ, x, y, z) for high scattering angles has similar spatial behavior for conventional seismic frequencies as it is driven mostly by ray theory. This assertion is true even for reasonably complex background velocity models. The data obtained from the mathematical model, or representation of such data, are compared with observed data or a representation of the observed data, resulting in wavefields or wavefield residuals, which can be utilized to update the model. In one embodiment, updates to the model may include providing an update/updates filter, conditioning, and/or decomposition corresponding to the same model of a single parameter or multi-parameter inversion in which such updates are scaled using an inversion for the scaling parameters. In one embodiment, comparing the mathematical model with the frequency domain data further includes comparing any form or representation or attribute of the frequency domain data.

As described in more detail below, in one embodiment a scattering angle filter can be applied to model updates or gradients to guide the sparse frequency data to the desired inverted model. The scattering angle filter may be a low-cut filter and/or an upper cut filter. As indicated above, the inverted model may include a single parameter and/or a plurality of parameters representing the inverted object physical properties. In one embodiment, the scattering angle filter is approximated using a velocity dependent filter. The combination of sparse frequency acquisition and a scattering angle filter provides a mechanism for efficiently inverting models of the Earth.

In this way, sparse-frequency sources can be utilized to generate sparse-frequency datasets dⱼ(t). Mono-frequency data is extracted from the recorded data through cross-correlation of the recorded data with similar frequency time source functions. The extracted mono-frequency data may then be utilized in waveform inversions, in which the observed data is compared to modeled data and used in feedback to correct the model until a minimum value of an objective is obtained. A benefit of the method described with respect to FIG. 1 is the sparse frequency dataset includes a large percentage of the information required to perform the waveform inversion, but requires a shorter sweep of frequencies to attain the required energy (hence the moniker “sparse frequency”).

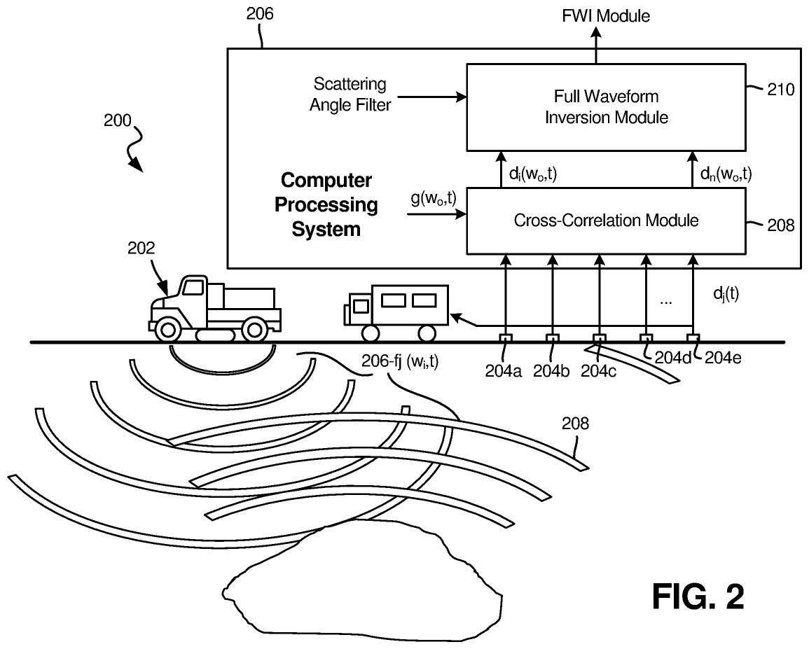

FIG. 2 is a schematic of single source system 200 according to an embodiment of the present invention. In the embodiment shown in FIG. 2, system 200 includes mono-frequency or narrow band source 202, a plurality of receivers 204a, 204b, 204c, 204d, and 204e (collectively, receivers 204), and computer processing system 206. Computer processing system 206 includes one or more processors, as well as memory for storing data received from receivers 204 as well as instructions for implementing tools for analyzing the received data, including cross-correlation module 208 and waveform inversion module 210.

Acquisition of the sparse mono-frequency data required for subsequent inversion steps requires either a series of mono-frequency signals be injected from a single source at the same or different times, or a plurality of sources are utilized to simultaneously inject a plurality of mono-frequency signals at the same time. In the embodiment shown in FIG. 2, a single source 202 is utilized to generate a series of mono-frequency signals. For example, mono-frequency signal fⱼ(ωᵢ,t) is injected into the earth from mono-frequency source 202. The mono-frequency signal fⱼ(ωᵢ,t) may be generated using a vibratory source located on the surface of the object to be imaged (e.g., earth) or in a borehole. In one embodiment, the frequency of the mono-frequency signal fⱼ(ωᵢ,t) is selected based on a confidence level associated with the current model and a resolution required with respect to the model.

Receivers 204a-204e collect data in response to the mono-frequency waveforms fⱼ(ωᵢ,t) generated by mono-frequency source 202. The collected data is represented by a vector dⱼ(t), where j corresponds to the source index, and the elements of the vector dⱼ correspond to each receiver. The collected data dⱼ(t) is provided to computer processing system 206 for processing.

In the embodiment shown in FIG. 2, cross-correlation module 208 receives the collected data dⱼ(t), which cross-correlates the data as described with respect to step 106 in FIG. 1, above. Cross-correlation of data includes cross-correlating the collected data dⱼ(t) with a source function g(ω₀, t), such as that described with respect to Equation 2, above. As a result of the cross-correlation process, monochromatic frequency data dᵢ(ω₀, t) is generated as described with respect to Equation 3, above. Alternatively, monochromatic frequency data may be expressed in the frequency domain as Dᵢ(ωₛ) as described with respect to Equation 4, above.

The monochromatic frequency data as expressed in either the time domain dᵢ(ω₀, t) or the frequency domain Dᵢ(ωₛ) is provided to full waveform inversion module 210, which utilizes the received monochromatic frequency data in an inversion process in which the monochromatic data is compared to modeled data and differences between the modeled and observed data are utilized to iteratively correct the model. As described with respect to FIG. 1, a plurality of methods may be utilized by inversion module 210, including full waveform inversion, waveform tomography, reflection full wave inversion (RWI), migration velocity analysis (MVA), or a combination of one or more of these methods. In the embodiment shown in FIG. 2, inversion module 210 utilizes full wave inversion, which may benefit from scattering angle based filtering to ensure convergence of the the sparse frequency dataset to a credible model. The output of inversion module 210 is the model converged to as a result of the comparison between the observed data (i.e., monochromatic frequency data) and the modeled data. That is, the model converges to a minimum value of an objective.

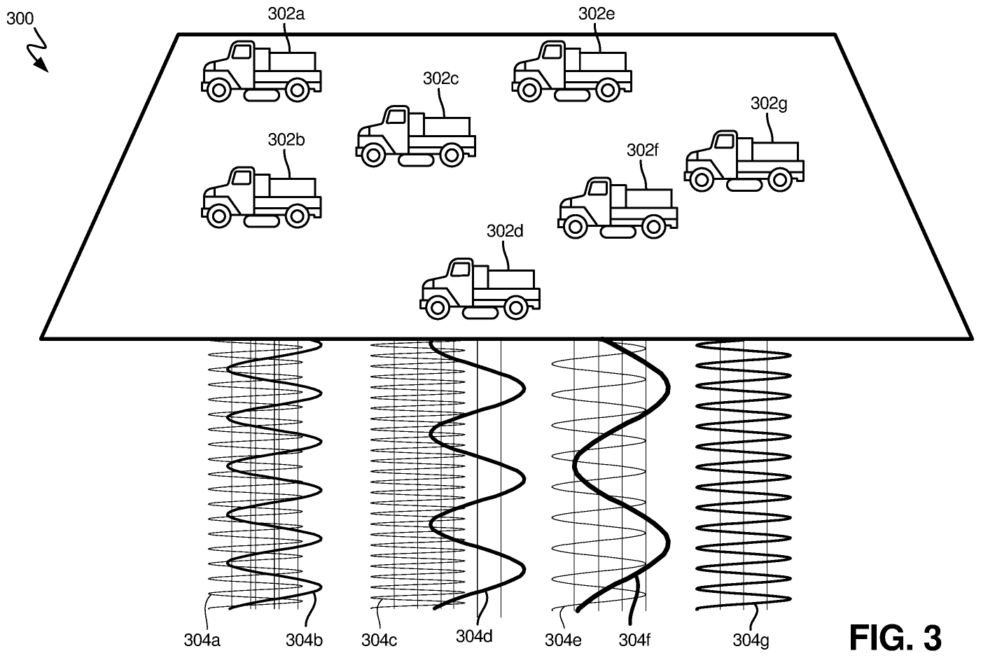

FIG. 3 is a schematic of a multi-source acquisition system 300 that utilizes a plurality of individual mono-frequency sources 302a, 302b, 302c, 302d, 302e, 302f, and 302g according to an embodiment of the present invention. This is in contrast with the embodiment shown in FIG. 2, in which a single source was utilized to generate at the same time or in sequence the plurality of mono-frequency signals making up the sparse frequency dataset.

In particular, the embodiment shown in FIG. 3 illustrates the ability to simultaneously generate and inject a plurality of mono-frequency signals into the earth for analysis. Specifically, in the embodiment shown in FIG. 3, mono-frequency source 302a generates mono-frequency signal 304a, mono-frequency source 302b generates mono-frequency signal 304b, mono-frequency source 302c generates mono-frequency signal 304c, mono-frequency source 302d generates mono-frequency signal 304d, mono-frequency source 302e generates mono-frequency signal 304e, mono-frequency source 302f generates mono-frequency signal 304f, and mono-frequency source 302g generates mono-frequency signal 304g. As illustrated, the frequency of each mono-frequency signal 304a-304g is unique within the spectrum of frequencies utilized as part of the sparse frequency dataset. For example, in one embodiment the spectrum of frequencies utilized are between approximately 7 Hz and approximately 40 Hz, with each frequency selected separated from adjacent selected frequencies. Separation may be fixed between the adjacent frequencies, or may be variable. In one embodiment, adjacent frequencies in the frequency sparse dataset are separated by approximately 2 Hz. In this embodiment, the frequencies selected for inclusion in the sparse frequency dataset have wavelengths less than the long wavelengths associated with changes and greater than the short wavelengths associated with interfaces. As discussed above, the sparse frequency dataset selected provide sufficient information to resolve both the long wavelength information (based on ray embedded features of the wavefields) and the short wavelength information (based on reflections in the data).

Mono-frequency signals may be expressed as fⱼ(ωᵢ, t), wherein ωᵢ represents the angular frequency of the source function and wherein each signal would be characterized by a different value of ωᵢ. In applications in which sub-surface structures are being imaged, mono-frequency sources 302a-302g may utilize a vibratory source located on the surface of the earth or in a borehole extending some depth into the earth.

In the embodiment shown in FIG. 3, a plurality of receivers (not shown) would be positioned to record frequency data generated as a result of the mono-frequency signals 304a-304g. The received data may once again be represented by a vector dⱼ(t), where j corresponds to the source index and the elements of the vector dⱼ correspond to each receiver. Following collection of the received sparse mono-frequency data dⱼ(t), the recorded data dⱼ(t) is cross-correlated in time (or in the frequency domain, as described above) with source functions having frequencies ω close to or equal to the frequencies generated by the sources 302a-302f. The cross-correlation process separates or de-blends the simultaneous recordings monitored by each receiver, and in particular allows recorded data existing at a particular frequency to be extracted from the received data dⱼ(t).

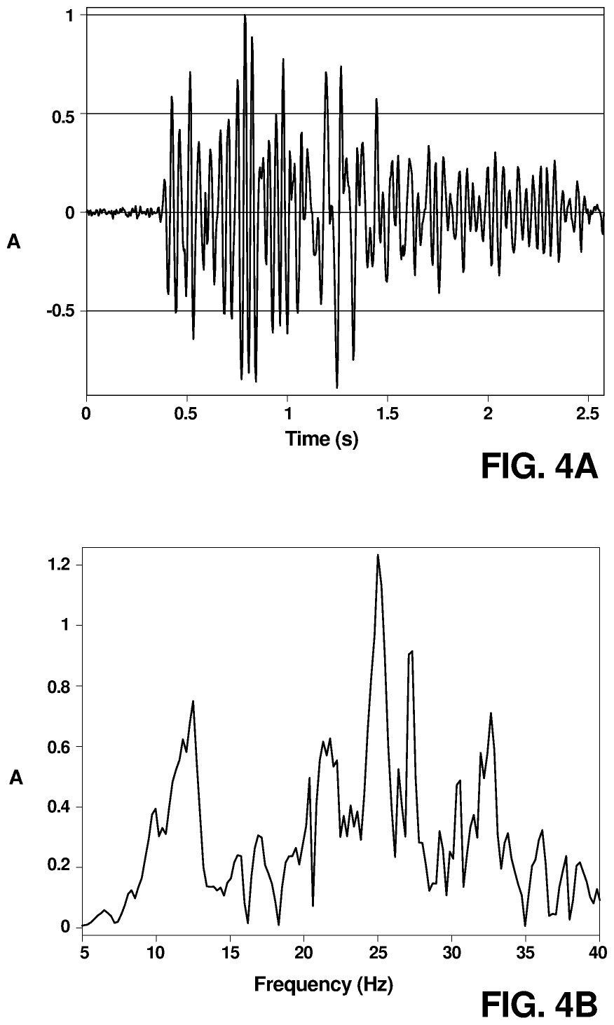

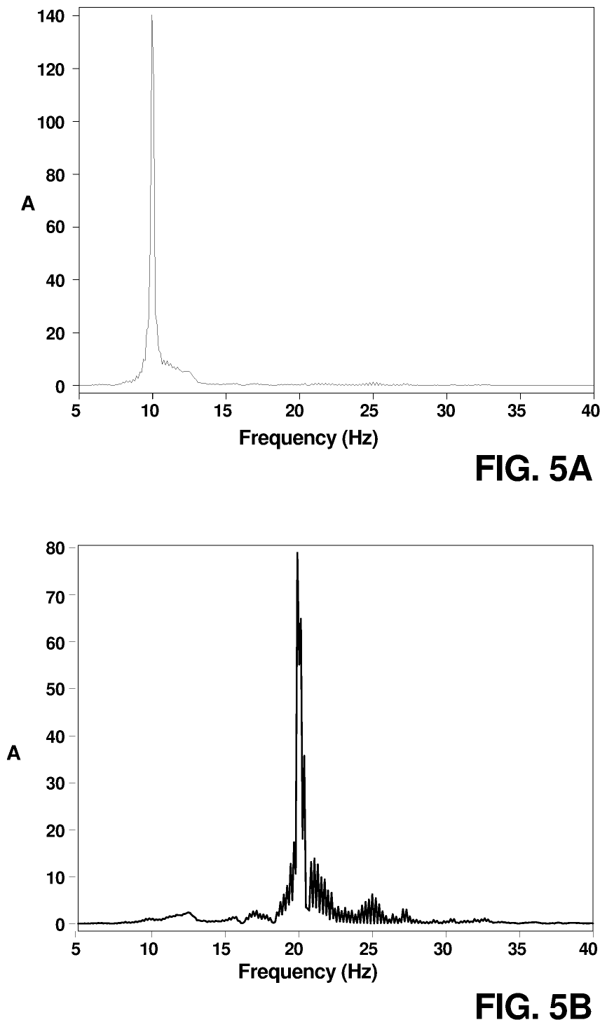

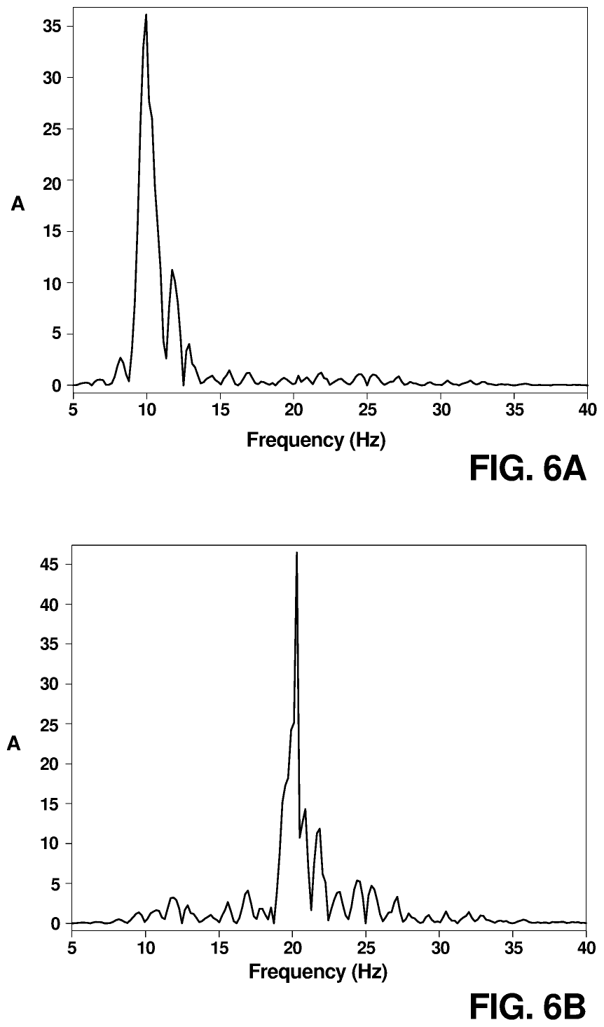

FIGS. 4a-6b are time-domain and frequency-domain graphs that illustrate how the length of the source function or time series determines the resolution (i.e., frequency) of the sparse mono-frequency nature of the resulting data and allows for the separation or de-blending of the recorded data dⱼ(t). In particular, FIG. 4a illustrates a received signal represented in the time-domain, and FIG. 4b illustrates the frequency spectrum of the data provided in FIG. 4a. In the embodiment shown in FIGS. 4a and 4b, the frequency spectrum of the data ranges from between 5 and 40 Hz. FIG. 5a illustrates cross-correlation of the data shown in FIGS. 4a and 4b with a 10 Hz mono-frequency time series having a length approximately equal as the length of the data (e.g., about 2.5 seconds). FIG. 5b illustrates an alternative in which the data shown in FIGS. 4a and 4b is cross-correlated with a 20 Hz mono-frequency time series having a length approximately equal to the length of the data (e.g., 2.5 seconds). FIGS. 6a and 6b illustrate cross-correlation with the data shown in FIGS. 4a and 4b, but wherein the length of the mono-frequency time series is about one-fifth (⅕) of the length utilized in FIGS. 5a and 5b.

With respect to FIG. 5a, the cross-correlation of the data shown in FIG. 4a with a 10 Hz mono-frequency time series signal having a length approximately equal to the length of the data illustrated in FIG. 4a results in the generation of a signal with energy centered at the respective 10 Hz frequency. Similarly, with respect to FIG. 5b the cross-correlation of the data from FIG. 4a with a 20 Hz mono-frequency time series signal (again having a length approximately equal to the length of the data illustrated in FIG. 4a) results in the generation of a signal with energy centered at the respective 20 Hz frequency. The cross-correlation shown in FIG. 5b illustrates some mild Gibb's phenomenon reverberations due to the sharp cut off of the sinusoidal signal. In one embodiment, the Gibb's phenomenon may be avoided or reduced by including a smooth taper. As discussed above with respect to the Equation 1—representing the source function fⱼ(ωᵢ, t)=A(t) sin ωᵢt−a taper may be added by modifying the amplitude A of the frequency with time t.

As compared with FIGS. 5a and 5b, FIGS. 6a and 6b illustrate cross-correlation with the data shown in FIG. 4a with a mono-frequency time series function having a length less than that utilized in FIGS. 5a and 5b. In this embodiment, the length of each mono-frequency time series is approximately one-fifth (⅕) of the the length utilized with respect to FIGS. 5a and 5b (i.e., approximately 0.5 seconds). The decrease in the length of the mono-frequency time series of 10 Hz (FIGS. 6a) and 20 Hz (FIG. 6b) reduces the resolution of the frequency. For example, the embodiment shown in FIG. 6a is less-focused than the embodiment shown in FIG. 5a, even though both are based on cross-correlation of the data shown in FIG. 4a with a 10 Hz mono-frequency time series function. Similarly, the embodiment shown in FIG. 6b is less focused than the embodiment shown in FIG. 5b, even though once again both are based on cross-correlation of the data shown in FIG. 4a with a 20 Hz mono-frequency time series function.

In addition, the amplitude of the cross-correlated signal shown in FIGS. 5a and 5b is greater than the amplitude of the cross-correlated signal shown in FIGS. 6a and 6b. The cross-correlated signal shown in FIG. 5a has an amplitude of approximately 140 decibels (dB), while the amplitude of the cross-correlated signal shown in FIG. 6a is approximately 35 dB. Similarly, the cross-correlated signal shown in FIG. 5b has an amplitude of approximately 80 dB, while the amplitude of the cross-correlated signal shown in FIG. 6b is approximately 45 dB.

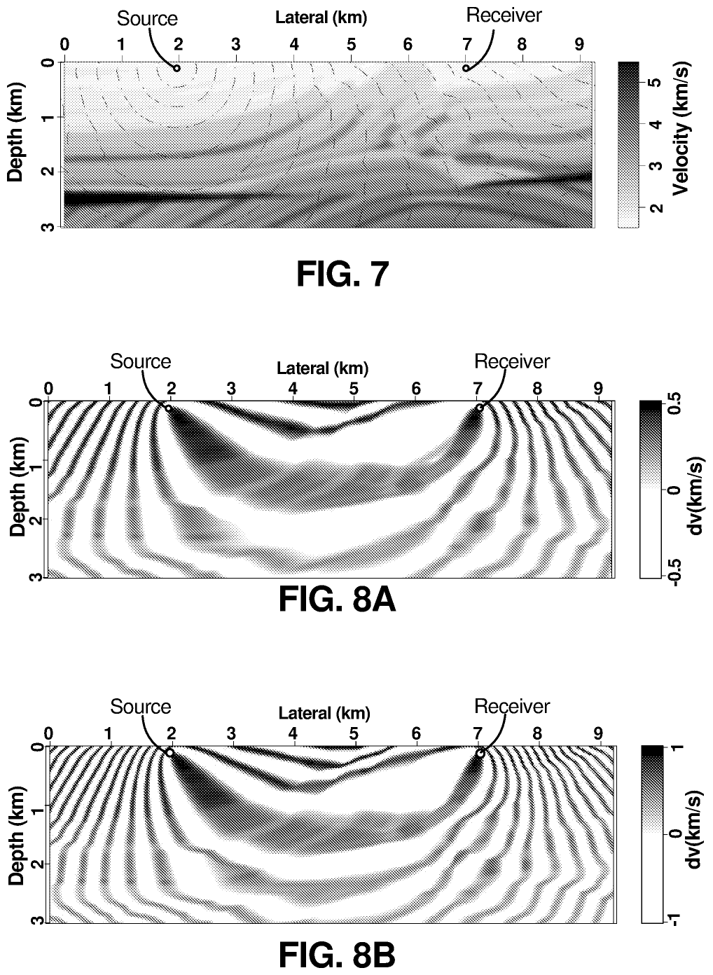

FIG. 7 is an image of a model representing a cross-section of a subsurface structure, with both the lateral distance and depth expressed in kilometers. The shading associated with the model indicates the background velocity and travel time contour, which is utilized in each of the subsequent analysis illustrated in FIGS. 8a-10e.

FIG. 8a illustrates the gradients generated as a result of a mono-frequency wavefield generated at the source at a frequency of approximately 5 Hz. FIG. 8b illustrates the gradients generated as a result of a mono-frequency wavefield generated at the source at a frequency of approximately 7 Hz. Both are based on the model background velocity shown in FIG. 7. The different frequencies can be seen in the resulting gradients constructed. In particular, the 5 Hz frequency utilized in FIG. 8a results in a longer gradient on average than that shown with respect to the 7 Hz frequency utilized in FIG. 8b.

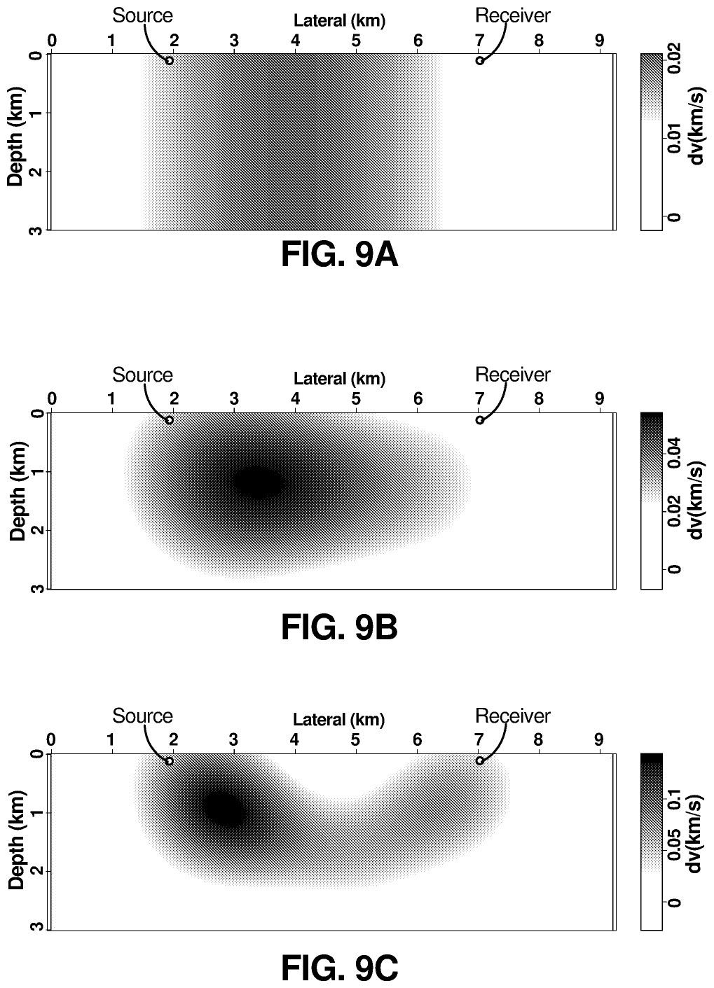

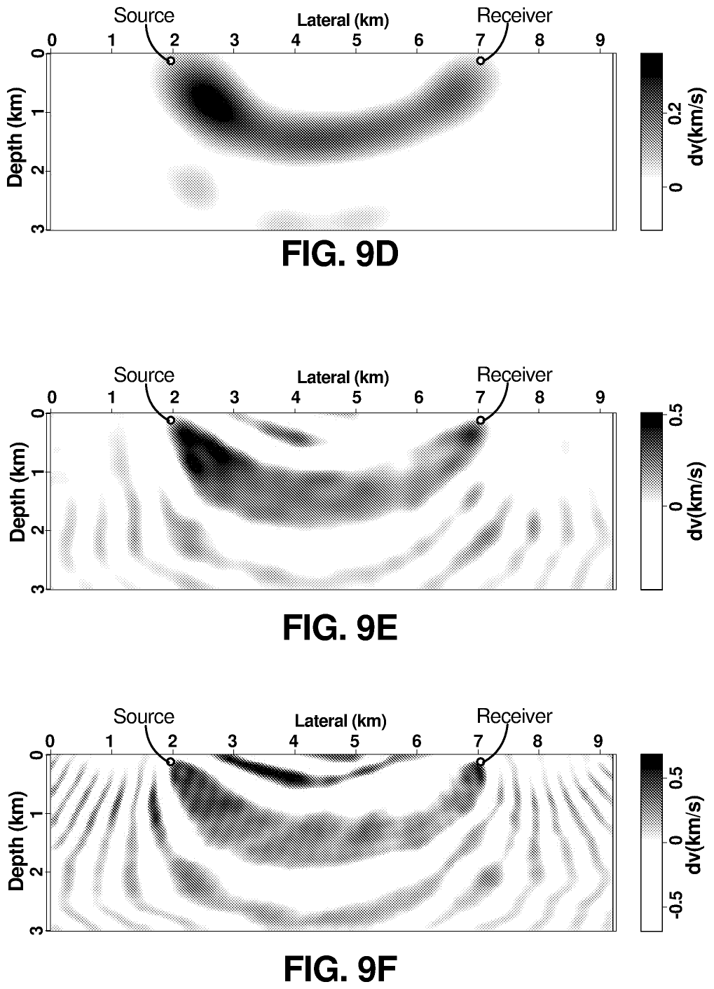

FIGS. 9a-9f illustrate the result of applying various low-cut scattering angle filters to the gradient shown in FIG. 8a (based on a 5 Hz source). In particular, low-cut scattering angles of approximately a) 179.4, b) 179, c) 178, d) 176, e) 170, and f) 160 degrees are applied in FIGS. 9a-9f, respectively. At a scattering angle of 179.4 degrees, only those transmission waves traveling directly between source and receiver are allowed (approximately 180 degrees), which results in very little resolution. As the scattering angle is decreased to allow rays reflected at different angles, then the resolution increases progressively as illustrated in FIGS. 9b-9f. As illustrated, the smoothness of the gradient enhances as the low-cut scattering angle decreases, allowing reflected rays.

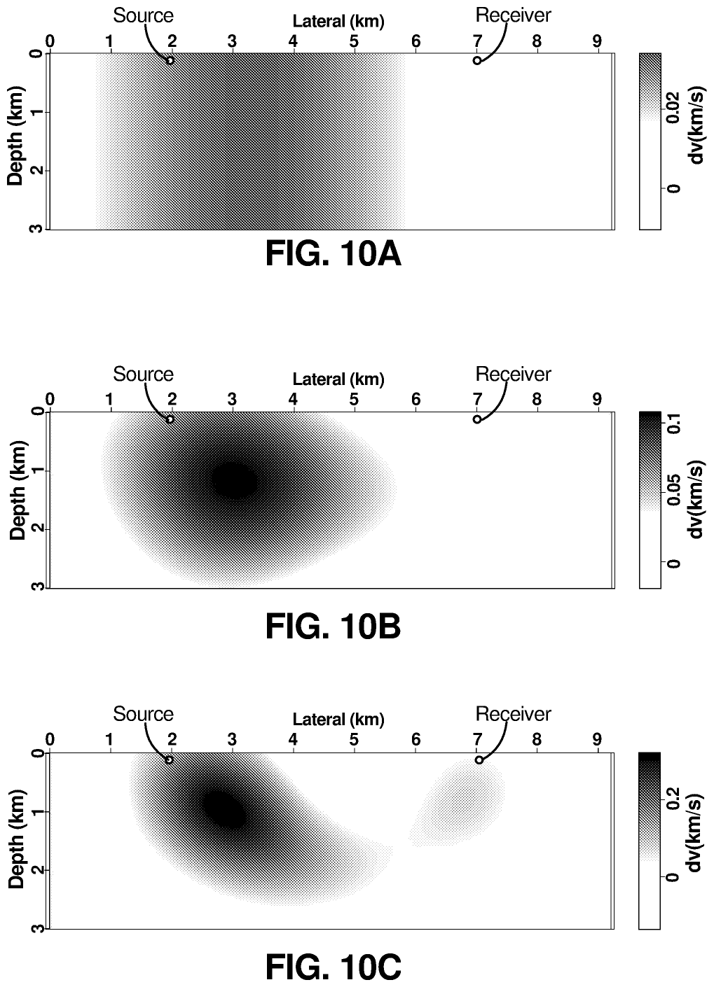

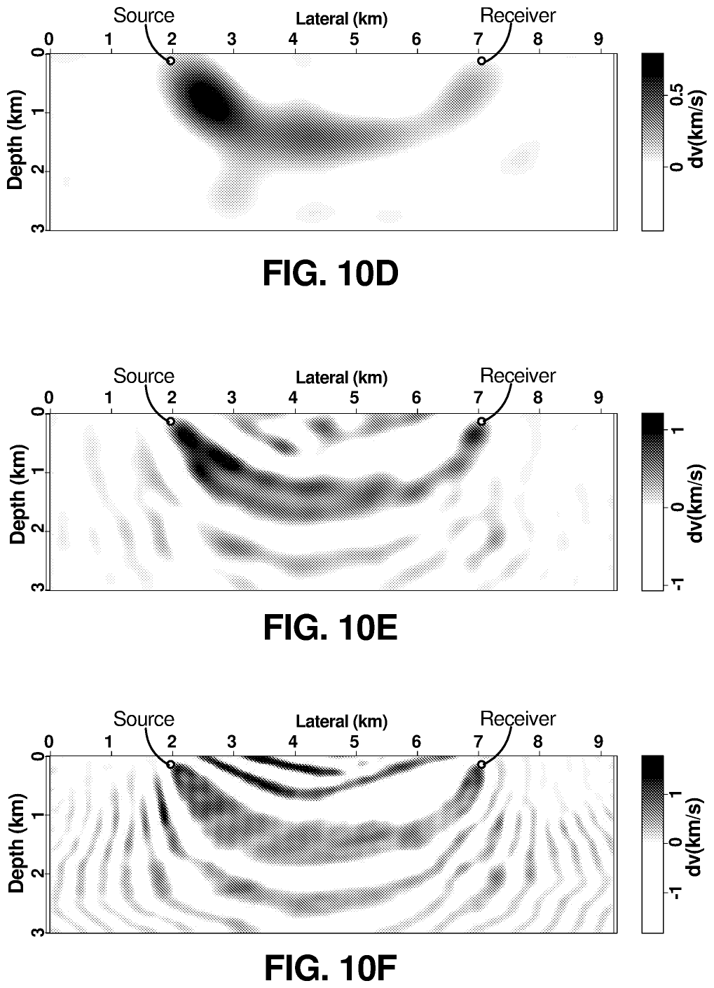

FIGS. 10a-10f illustrate the result of applying various low-cut scattering angle filters to the gradient shown in FIG. 8b (based on a 7 Hz source). Once again, low-cut scattering angles of approximately a) 179.4, b) 179, c) 178, d) 176, e) 170, and f) 160 degrees are applied in FIGS. 10a-10f, respectively. At a scattering angle of 179.4 degrees, only those transmission waves traveling directly between source and receiver are allowed (approximately 180 degrees), which results in very little resolution. As the scattering angle is decreased to allow rays reflected at different angles, then the resolution increases progressively as illustrated in FIGS. 10b-10f. As illustrated, the smoothness of the gradient enhances as the low-cut scattering angle decreases, allowing reflected rays.

In one embodiment, the scattering angle filter is selected to control the information extracted from the mono-frequency data to inject the proper model frequency or wavenumbers. In some embodiments, selecting and modifying the scattering angle filter is required to allow model content to be constructed from low frequency/wavenumbers to high frequency/wavenumbers. In particular, this method prevents construction of a model that converges to a local minima, as opposed to the desired global minima. A benefit of utilizing a scattering angle filter is that it blankets the sparsity that results from the sparse-frequency dataset. In addition, the plurality of mono-frequency waveforms may also be selected to provide a continuation of frequencies/wavenumbers to allow for construction of the model.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of imaging an object, the method comprising:
generating a plurality of mono-frequency waveforms and applying the plurality of mono-frequency waveforms to the object to be modeled;
acquiring sparse mono-frequency data in response to the plurality of mono-frequency waveforms applied to the object to be modeled;
cross-correlating the sparse mono-frequency data with one or more source functions each having a frequency approximately equal to each of the plurality of mono-frequency waveforms to obtain monochromatic frequency data; and
utilizing the monochromatic frequency data in an inversion to converge a model to a minimum value of an objective.

2. The method of claim 1, wherein the one or more source functions utilized for cross-correlation has a length of time selected to ensure orthogonality of the monochromatic frequency data.

3. The method of claim 2, wherein the plurality of mono-frequency waveforms are each defined by a unique frequency, wherein the frequencies of the mono-frequency waveforms depends on a confidence associated with a current model and the required resolution.

4. The method of claim 2, further including applying Fourier transform to acquired sparse mono-frequency data.

5. The method of claim 4, wherein the plurality of mono-frequency waveforms are selected to provide a frequency range for the entire model.

6. The method of claim 1, further including applying a scattering angle filter.

7. The method of claim 6, wherein the scattering angle filter includes at least one of a low-cut filter and an upper cut filter.

8. The method of claim 6, wherein the scattering angle filter is selected to control information extracted from the mono-frequency data.

9. The method of claim 1, wherein the plurality of mono-frequency sources applied to the object to be modeled are applied simultaneously.

10. An imaging system comprising:
at least one mono-frequency source capable of generating one or more mono-frequency waveforms directed to the object being modeled;
at least one recorder configured to monitor and record sparse mono-frequency data generated in response to the one or more mono-frequency waveforms;
a computer processing system cross-correlates the sparse mono-frequency data with one or more source functions each having a frequency approximately equal to each of the plurality of mono-frequency waveforms to obtain monochromatic frequency data, and further utilizes the monochromatic frequency data in an inversion to converse a model to a minimum value.

11. The imaging system of claim 10, wherein the mono-frequency source is an acoustic, seismic, pressure, or electromagnetic source.

12. The imaging system of claim 10, wherein the source functions are monochromatic time series signals.

13. The imaging system of claim 10, wherein the one or more source functions has a length of time selected to ensure orthogonality of the monochromatic frequency data.

14. The imaging system of claim 10, wherein the computer processing system applies a scattering angle filter to the monochromatic frequency data to guide the sparse frequency data to an inverted model.

15. The imaging system of claim 14, wherein the scattering angle filter includes at least one of a low-cut filter and an upper cut filter.

16. The imaging system of claim 15, wherein the scattering angle filter is selected to control information extracted from the mono-frequency data.

17. The imaging system of claim 10, wherein the at least one mono-frequency source includes a plurality of mono-frequency sources that simultaneously generate mono-frequency waveforms directed to the object to be modeled.
